(19) United States
(12) Patent Application Publication
(10) Pub. No.: US 2012/0228117 A1
(43) Pub. Date: Sep. 13, 2012

(54) SYSTEM AND METHOD OF PURIFYING AND RECYCLING OR DISCHARGING SEPTIC TANK EFFLUENT, GRAYWATER, RAINWATER AND STORMWATER

(76) Inventor: Mindy S. Panunzio, Malibu, CA (US)

(21) Appl. No.: 13/415,772

(22) Filed: Mar. 8, 2012

Related U.S. Application Data
(60) Provisional application No. 61/450,390, filed on Mar. 8, 2011.
(60) Provisional application No. 61/485,449, filed on May 12, 2011.
(60) Provisional application No. 61/595,890, filed on Feb. 7, 2012.

(51) Int. Cl. C02F 1/04; B01D 3/00

(52) U.S. Cl. 203/10; 202/163

(57) ABSTRACT

Methods and systems are disclosed which provide for the purification of effluent from a septic system or natural water from rainwater or stormwater collection devices for the storage and reuse of water. The purified water may be supplied to water applications, such as a return conduit to a home for potable or graywater usage. The distillation unit may be powered by a local power independent of a municipal power grid and which may employ sustainable energy mechanisms. The distiller residue may undergo a volume reduction process, such as evaporation, coagulation, electrocoagulation or microfiltration. The purified water may be stored in a holding tank with sensors to monitor the water quality and water level within the tank. Alarms, release valves or relief valves may be activated in response to such monitoring.

### RELATED APPLICATIONS

This application claims the benefit of U.S. Provisional Application No. 61/450,390, filed on Mar. 8, 2011, U.S. Provisional Application No. 61/485,449, filed on May 12, 2011, and U.S. Provisional Application No. 61/595,890, filed Feb. 7, 2012, the contents of each of which are incorporated by this reference in their entirety for all purposes as if fully set forth herein.

### TECHNICAL FIELD

The present invention relates generally to systems and methods for purifying and recycling water. More particularly, embodiments of the invention relate to systems and methods for producing purified water from septic tank effluent or other non-purified water sources, and then filtering, storing and reusing the purified water for potable, household or other applications.

### BACKGROUND

Where there are no regional publicly-owned wastewater treatment plants, residential wastewater is handled with onsite wastewater treatment systems (otherwise referred to herein as “OWTS”). These facilities range from individual septic systems providing minimal treatment to newer package plants providing tertiary treatment and disinfection. No matter what the level of treatment, all OWTS must somehow dispose of the wastewater.

Nearly one in four households in the United States depends on an individual septic (onsite) system or small community cluster systems to treat wastewater. Nationwide, decentralized OWTS (septic systems, private sewage systems, on-site sewage disposal systems) collect, treat and release about four billion gallons of effluent per day from an estimated 26 million homes and businesses (USEPA, 2002). More than half of OWTS were installed more than 30 years ago when rules were nonexistent, substandard or poorly enforced.

Most typically, wastewater from OWTS flow into septic tanks where the heavier solid materials settle to the bottom (forming a sludge layer), the lighter greases and fats float to the top (forming a scum layer), and the liquid (sewage effluent) flows out of the tank. These systems are known as “anaerobic” systems. Anaerobic means or requires the absence of oxygen, and in the context of OWTS means anaerobic decomposition by bacterial organisms. An outlet baffle (or a sanitary tee at the outlet end) prevents solids from flowing out with the liquids. The tank's primary purpose is to retain the solids and act as a bioreactor where microorganisms break down organic matter in the wastewater to liquids, gases and solids while releasing sewage effluent to a drain field. Treatment of the wastewater occurs in the soil beneath the drain field. Sewage effluent flows out of the tank as a cloudy liquid that still contains many biological and chemical pollutants, flows into the perforated pipe in the trenches, passes through the holes in the pipe, and then trickles down through the gravel into soil. As effluent enters and flows (or “percolates”) through the pore spaces, the soil microbes treat the effluent before it enters the ground water. When working properly, certain bacteria and viruses are filtered and certain of the chemicals, including phosphorus and some forms of nitrogen are absorbed by the soil. The type of soil impacts the effectiveness of the drain field, with dry permeable soils with plenty of oxygen working best and clay soils often too tight to allow for pore spaces.

Unfortunately, soil-based systems OWTS (with a leach or drain field and other systems that includes seepage pits) are often installed at sites with inadequate or inappropriate soils, excessive slopes or high ground water tables. Increased groundwater levels induced by wastewater disposal are also a concern due to the potential for day-lighting along slopes, increased slope instability resulting in landslides, and flooding of neighboring drain fields. Furthermore, these systems must work all year and infiltrate during wet springs and cold winters and the area of soil absorption must be sufficiently sized so it can handle the daily wastewater flow from a residence, as well as effectively decompose the biological materials in the effluent. Many single family lots are not large enough to maintain an adequately sized drain field. The ability of the soil to treat and infiltrate the effluent is also based on the texture and local hydrology at the depth the effluent is introduced to the soil. OWTS that use seepage pits are even more problematic because they can disperse effluent in anoxic or oxygen-poor, environments, where pathogens (especially viruses) may not be treated before they reach the water table. All of the above geological conditions, as well as aging OWTS systems and poor maintenance cause hydraulic failures and, consequently, water resource contamination, to streams, rivers and oceans. Moreover, water that flows from a drain field into soil and eventually ground water (treated adequately or not) cannot, without large expenditures of energy, be accessed for reuse.

Graywater constitutes about 50% of the total wastewater generated within a household. Although average household use varies by location and venue, a significant amount of graywater per day per household is available for reuse but is instead more often treated like blackwater and released to the drain field. The use of household graywater for reuse for landscape irrigation is gaining in popularity in the United States; however, fecal coliform counts reported for graywater indicate a potential health risk association with graywater reuse with most current systems. Also, constituents in typical graywater (from most current systems) are known to be potentially harmful to plants singly or in combination with other chemicals in graywater.

Massive quantities of water are consumed to generate energy and massive quantities of energy are used to deliver clean water for human consumption. Energy is required to move and treat water, sometimes across vast distances. The California Aqueduct, for example, which transports snowmelt across two mountain ranges to coastal cities, is the biggest electricity consumer in California. Local municipalities must clean incoming water and, where OWTS are not utilized, municipalities must also treat wastewater. Treatment of water consumes about 18% of California's electricity and 3% of the nation's electricity. Power plants that are needed to generate the electricity to treat wastewater are the second biggest users of freshwater, after agriculture. Water is increasingly energy-intensive to produce resulting in continued reliance on fossil fuels for pumping water from deeper aquifers or for moving it through longer pipelines. The use of fossil fuels, of course, creates greenhouse gases and is contributing to climate change, which may, in turn, be causing more severe droughts. According to the World Health Organization, approximately 2.4 billion people live in highly water-stressed areas so the systems and methods according to the present invention will be useful worldwide.

Over the last decade, the USEPA has funded millions of dollars in research projects conducted by the Coalition for Alternative Wastewater Treatment (the “Coalition”), which in conjunction with Water Environment Research Foundation (WERF), produced a series of research papers describing the need for a wholesale paradigm shift. The Coalition, WERF and others are calling for a paradigm shift away from large centralized systems to “a trio of decentralized water-efficiency, storm water retention and reuse and wastewater treatment and reuse,” which WERF believes “have the greatest potential to reduce dramatically the amount of water taken out of aquifers and streams and to reduce wet weather runoff and sewer flows going back in the environment.” “Big-pipe, centralized infrastructure for water, storm water and wastewater services are not sustainable over the long-term. These municipal systems consume too much water, disrupt too many ecosystems and use too much energy to move water and wastewater around. Growing populations, increasing land development and climate change will make these problems much worse.” Sustainable water systems in the future, the Coalition and WERF conclude in the abstract entitled, Non-Governmental Organizations: Enhancing their Role in Advancing the New Water Infrastructure Paradigm (2010), will use, treat, store and reuse water efficiently at a small scale. This invention is capable of capturing, treating and reusing graywater, storm water as well as wastewater and is intended to answer the long felt need in the industry for a sustainable water infrastructure.

### 1. Discussion of Existing OWTS Technology

While there are numerous ways to treat wastewater for residential use, few allow for the reuse of the wastewater and none assure that all contaminates are eliminated from the effluent before being discharged into the environment. The “traditional OWTS” described above is meant to refer to an anaerobic treatment of wastewater with the release of effluent into a drain field or seepage pit of native soils.

Aerobic Treatment Units, sometimes referred to as “ATU,” “advanced systems,” “alternative systems” or “tertiary systems” are similar to the typical OWTS in that they both use natural processes to treat wastewater, but unlike septic (anaerobic) treatment, the ATU aerobic treatment process requires oxygen, therefore ATUs use a mechanism to inject and circulate air inside the treatment tank. Bacteria that thrive in oxygen-rich environments break down and digest the wastewater inside the aerobic unit as they are suspended in the liquid and effluent holding time within the unit can be reduced. These Aerobic Treatment Units act like a miniature municipal treatment plants but designed for a single family rather than an entire city or community. The oxygen components used in these systems accelerate the treatment process through the creation of an optimum environment for microorganisms that digest the waste, and for collection and storage of the resulting byproducts. This results in much cleaner effluent when it leaves the septic tank, and before the effluent is allowed to pass into the drain field. Appropriately designed, required drain field areas are reduced allowing these advanced onsite wastewater systems to be placed in areas where a conventional system would not fit. Due to the improved quality of effluent produced from these advanced or tertiary septic systems they can frequently be placed in areas where bedrock and high historic groundwater levels exist or on soils with low permeability that would not adequately accept conventional septic effluent. The effluent generated by these tanks is superior in treatment level to that of a typical OWTS and the treated effluent may sometimes be used for surface irrigation, but it is usually discharged to a smaller drain field, or discharged directly to a drainage ditch or open waterway. If the treated effluent is discharged directly to the surface, most systems must include disinfection devices to reduce the microorganisms present in the treated effluent. While wastewater treated in this manner is sometimes safe for discharge to the environment, it is often unsafe for contact with humans. There are pathogenic bacteria and other microbial health concerns associated with treated effluent. To ensure these organisms are reduced to a level of safe human contact, disinfection devices are often used. The most common is chlorine disinfection, utilizing either chlorine tablets or liquid chlorine UV light is sometimes used so that effluent can be discharged to the surface or to ground water or even streams and waterways.

Various proprietary filters have been developed for use in septic tanks to filter the effluent prior to discharging it either to the leach field, or to further treatment processes. One type of filter uses a series of plastic trays, and another filters the effluent through a series of long tubes and screens as the effluent flows upward through the outlet pipe of the septic tank. These filters can provide for enhanced solids removal, with associated biological oxygen demand (BOD) reduction.

Various material media filtration systems have been developed using sand beds, filter beds, peat filters, synthetic textile filters, rotating biological contractor systems, trickling filters, foam media filters including above-ground self-contained systems. These systems provide for non-native soil drain fields that provide the environment for the naturally occurring processes that occur in native soil drain fields. Using electrical means, final treatment of the effluent can be confined to a very small area. In these systems, water well pumps move the effluent around and, sometimes through synthetic filters, ultimately sending the pre-treated effluent to a disposal site, such as a small drain field or, if the treated effluent undergoes further disinfection, it may sometimes be dispersed underground by a drip irrigation system.

Cities that have enacted regulations permitting advanced OWTS, such as the City of Malibu in California, report that installing them (or even traditional OWTS) cost homeowners $80,000 to $130,000 for a standard single family residence. These costs are dependent upon sufficient percolation rates for dispersal and sufficient area for system installation. Costs may increase when these and other variables are unfavorable.

### 2. Discussion of Existing Graywater and Rainwater Reuse Technology

There are many ways to treat graywater for reuse. For example, Art Ludwig's Create an Oasis with Graywater: Choosing, Building and Using Graywater Systems (5^{th} Ed. February 2006), discusses ways to save blue water and irrigate with gray water. Present manufactured systems range from simple collection of graywater without treatment to more complex systems that act like a miniature municipal treatment plants but designed for a single family rather than an entire city or community. The components used in these systems sometimes accelerate the treatment process through the creation of an optimum environment for microorganisms that digest the waste, and for collection and storage of the resulting byproducts. Frequently these systems pump the gray water or natural source water through a treatment cell where biological treatment together with chemical and physical removal processes take place. However, more typically, graywater systems are quite simple. They are usually gravity drains from the washing machine or graywater collection system. The minimum treatment is to use coarse filtration mesh screen to remove large objects like hair, thread, and lint. These systems perform more like graywater disposal systems than irrigation systems. Earthstar Graywater, for example is a graywater system, the components of which are a 12- or 55-gallon tank, sand filter, automatic float switch and a pump. The system is intended for irrigation use. The sand filter is used for tank water cleaning; an automatic backwash is applied every two months. A more sophisticated graywater system for toilet flushing from Germany looks like a miniature wastewater treatment plant. It includes coarse filter, two chambers, UV disinfection unit, storage tank, and backup potable water feed if the graywater is not enough to feed the toilets. Most states that regulate graywater irrigation specify a simple graywater system that include storage and, in some states, coarse filtration such as the California Graywater System.

Rainwater harvesting is an ancient technique enjoying a revival out of necessity on small volcanic, coral islands, Australia and elsewhere as water becomes more expensive. Rainwater harvesting is the collection, conveyance, and storage of rainwater, and if used for potable reuse, the treatment of the rainwater. There are many ways to harvest rainwater and storm water. See, generally, Kinkade-Levario, H. (2007), Design for Water: Rainwater Harvesting, Stormwater Catchments and Alternative Reuse. Rainwater harvesting is practical only when the volume and frequency of rainfall and size of the catchment surface can generate sufficient water for the intended purpose. Rainwater is less problematic then graywater for reuse because of its initial purity and softness. It has a nearly neutral pH, and is free from disinfection by-products, salts, minerals, and other natural and man-made contaminants. Rainwater harvesting can reduce the volume of storm water, thereby lessening the impact on erosion and decreasing the load on storm sewers. But, there are high maintenance requirements such as purging the first flush system, regularly cleaning roof washers and tanks, maintaining pumps and filtering water. Presently, to make rainwater potable, systems include cartridge filters, disinfection equipment, and water testing to assure there are no pathogens. Present rainwater reuse systems require boiling, chemical treatments (liquid, tablet, or granular within tank or at pump), ultraviolet light (after activated charcoal filter before tap) ozonation (after activated charcoal filter, before tap), nanofiltration (before use; polymer membrane) or reverse osmosis (before use; polymer membrane). The invention described herein will be particularly useful where rainwater is intended for potable reuse.

### BRIEF SUMMARY OF THE INVENTION

Aspects of the present invention pertain to a system and method, certain embodiments of which will provide for the distillation of effluent discharged from small venues, such as residential onsite wastewater treatment systems, (herein referred to collectively as, “OWTS”), which include septic systems, private sewage systems, and on-site sewage disposal systems, and for either (a) the reuse of the distilled water in the residence or other venue for (i) all purposes including drinking water; or (ii) for irrigation, flushing toilets, and other non-potable (graywater) purposes only; or (b) the discharge of the distilled water directly into adjacent soils or by injection well, or a body of water, such as a stream, lake or ocean, or any combination of (a) and (b) directly above.

Aspects of the present invention may also pertain to a system and method for treating by distillation in small venues, such as residence, “natural source water” (e.g., rainfall, and storm water runoff) and/or “graywater” (e.g., water from laundry, shower, bathtubs, bathroom sink), for either (a) the reuse of the distilled water in the residence for (i) all household purposes including drinking water; or (ii) for irrigation, flushing toilets, and other non-potable (graywater) purposes only; or (b) with respect to purified graywater, the discharge of the distillate directly into adjacent soils or by injection well, or a body of water, such as a stream, lake or ocean, or any combination of (a) or (b) directly above.

The systems and methods mentioned above may be adapted to work independently and/or interdependently at the same venue.

A system in accordance with the present invention will be set up like a traditional OWTS, in that wastewater (greywater and blackwater) will flow from the home to the septic tank, preferably an alternative tank system (described below). An automatic effluent flow valve will allow effluent to leave the septic tank or be drawn from the septic tank or other “clarifier” (either way, at a flow rate to be determined by design needs) and flow or be pumped via, for example, an effluent pump station, and in one embodiment, into a pre-treatment system, for example, using “coagulation,” “electrocoagulation” or “micro filtration” or other filtration method that will separate undesirable contaminants before the effluent is pumped or drawn into an energy efficient “Distillation Unit” such as, for example, the vapor water distillation component of the locally powered water distillation system described U.S. Pat. No. 7,340,879 or a pressurized vapor cycle liquid distillation unit described in U.S. Pat. No. 7,597,784, or a distillation unit using a rotating plate heat exchanger described in U.S. Pat. No. 6,261,4196, or a distillation unit using a rotating fluid evaporator and condenser described in U.S. Pat. No. 6,846,387, (together or any, “current state-of-the-art distillation units”). The Distillation Unit may be powered by electricity from, for example, a municipal power grid, or may be coupled with a local power source operating independently of, for example, a municipal power grid. Such a local power source may comprise, by way of example, an electric generator driven mechanically by a Stirling cycle engine. Fuel may be provided by, for example, obtaining biogas from the “aerobic” or “anaerobic” digestion occurring in the septic tank, or any other locally available fuel, or may, instead, be combined with or powered by a separate solar energy system, or any other kind of locally generated power sufficient to power the Distillation Unit. If the distilled water is intended to be reused, it may flow (in one embodiment) to a water holding tank sized and with materials appropriate to hold the expected volume of distillate.

From the water holding tank, the distilled water can be directed by a water pumping station, if necessary, to the main water inlet of the home and used for all purposes, or plumbed within the home with the use of a back flow protection device and color coded water lines consistent with current statutes and regulations to assure that the use of the water is restricted to purposes such as toilet flushing and irrigation. If the distilled water will not be reused, it may flow from the Distillation Unit to a body of water capable of receiving the distilled water, such as a creek, stream, river, lake, and ocean or directed underground for drip irrigation, surface irrigation or by injection well in such a manner as to avoid erosion, and in any drainage system approved by local authority. In order to avoid residue build-up and wear of the Distillation Unit a percentage, possibly as much as 30-40% of the distiller waste may flow via conduit, ejector basin or sump basin back into the septic tank or into the sewer line leaving the home or venue before being introduced to the septic tank. In one embodiment, the distiller waste may be held separately in a tank, and in one embodiment, be made subject to an evaporator, coagulation, electrocoagulation or microfiltration and then reintroduced to the Distillation Unit in a controlled manner in order to allow for controlled reintroduction of especially corrosive properties that may affect the Distillation Unit operations, or some percentage of the distiller waste may be stored, in one embodiment, in a separate hazardous waste tank for collection by an authorized hauler and properly disposed offsite in accordance with current regulations.

In another embodiment, a system in accordance with the present invention will be specially plumbed within a residence or small business to separate blackwater, being water contaminated with animal, human, or food waste, from graywater, Natural source water, will be harvested, and in one embodiment, directed to a swimming pool where the natural source water will be stored and filtered in a manner customary for swimming pool use or otherwise filtered to remove additional contaminates from the source water and then stored until required for reuse. Any harvested natural source water together with or separated from graywater, will be directed to flow from the home, swimming pool, storm water catchment or rainwater cistern by gravity or be pumped via, for example, pump station into an energy efficient Distillation Unit such as, for example, those in the current state-of-the-art distillation units. The Distillation Unit may be powered as described above.

If the distilled water is intended to be reused, it may flow (in one embodiment) to water holding tank sized and with materials appropriate to hold the expected volume of distillate. From the water holding tank, the distilled water can be directed by a water pumping station, if necessary, to the main water inlet of the home and used for all purposes, or plumbed within the home with the use of a back flow protection device and color coded water lines consistent with current statutes and regulations to assure that the use of the water is restricted to graywater purposes such as toilet flushing and irrigation. In one embodiment the system, where distilled water is not used for irrigation, will form a closed loop and the distillate will be reused continuously. In such an embodiment appropriate hydrology specifications may require a certain amount of graywater return to the sewage line to allow for adequate continued maintenance of the sewer plumbing functions. If the distilled water will not be reused (and the source is other than rainwater), it may discharge from the Distillation Unit as drip irrigation or spray landscaping or by injection well into porous rock formations, or be discharged into a body of water capable of receiving the distilled water, such as a creek, stream, river, lake, ocean or directed underground e.g., groundwater recharge, or, in such a manner as to avoid erosion, and in any drainage system approved by local authority. The distiller waste may flow via conduit back into the septic tank or may be reintroduced to the sewer line leaving the home or venue before being introduced to the septic tank. The distiller waste may be held separately in a tank, in one embodiment, and be made subject to an “evaporator,” “coagulation,” “electrocoagulation” or “micro filtration” before reintroducing the distiller waste into the septic tank or before directing to the distiller waste to a separate hazardous waste container for future disposal.

Estimates vary, but Americans use about 45-100 gallons of water per day each. The WERF Report concludes the median indoor water use of a family of four is 171 L//d (45.2 gped) which is 25% lower than studies conducted 10 years previous which showed 60.5 gped. Nonetheless, in California, some local jurisdictions plan on a typical family of four consuming 450 gallons of water per day. A system and method in accordance with the present invention eliminates the need for drain fields, leachfields, or seepage pits because the Distillation Unit will treat the effluent by distillation thereby removing all contaminates, before discharge. Such a system, unlike present systems, can be installed anywhere without consideration of geological conditions or size of land available for such drain fields. Presently potable reuse of effluent requires treatment by flocculation, dissolved air floation clarifier, sand filtration, activated carbon treatment and membrane filtration. Next it must be treated by reverse osmosis and disinfection process, such as chlorinization, ozonation and UV irradiation. The distilled water produced by the Distillation Unit is expected to meet EPA guidelines as well the California standard for unrestricted reuse, known as “Title 22” water, which is the highest standard in the nation. No further filtration or disinfection is required after the effluent passes through the Distillation Unit of certain embodiments of this invention except as may be disclosed in the current state-of-the-art distillation units. Because the effluent has been purified to such a high standard, the distillate can be reused for all potable purposes and\or for typical graywater purposes. The EPA estimates that 32% of average residential water use is for outdoor uses such as irrigation, while an additional 28% is used for toilet flushing

Distillation is the only process that replicates the hydrological cycle: water is heated until it forms steam; the steam is cooled to condensation, creating water, minus the impurities left behind in the boiling. It is a simple evaporation-condensation-precipitation system. Because of the extended boiling process, any microbiological contaminants, including Cryptosporidium, are killed. Distilled water falls within the EPA's definition of “purified water.” Distillation removes both organic and inorganic particles, including radioactive materials and bacteria. Vapor compression distillation is not new. However, the cost of energy required to heat the water to boiling in the distillation process has previously been too expensive. The Distillation Unit will efficiently trap, treat and distill the water, which takes in one embodiment only 2 percent of the power of conventional distillers, and in another embodiment even less. Essentially, the heat put into the water is recovered with a “counter-flow heat exchanger” and recycled to heat the next batch of water. Depending on local electricity rates, power costs could be as low as 0.003 to 0.04-cents per gallon. Depending on the geographic location, municipal water costs on average range between 0.0027 and 0.0060-cent per gallon. With no moving parts, there is almost nothing that could wear out and no replaceable filters or chemical additives are required, eliminating many of the problems associated with poor septic system maintenance. The system eliminates the enormous cost of geological testing, percolation, siting and development of drain fields, leachfields and seepage pits. Distilled water, unlike water released from current graywater systems, is very beneficial for landscaping and agricultural uses.

An embodiment of this system would use the swimming pool as a holding tank or cistern, thus avoiding perhaps the biggest cost of current rainwater and stormwater collection systems. Because large amounts of water need to be collected in order to make these systems useful, large cisterns or holding tanks are required which are expensive, sometimes require excavation in order to site them underground and otherwise require large land areas to accommodate them.

The reuse systems described herein will, except when reused for irrigation, form a closed loop, thereby allowing for the continued reuse of the same initial source water, subject to losses due to evaporation. Where such a system is needed in remote locations without access to municipal water supplies, the initial source water can be brought to the remote site by truck, or local water supplies (e.g., streams and ponds) can be used to initiate the use of the system for continued reuse, and may in certain embodiments be replenished as needed by rainwater or stormwater. The EPA has determined that sustainable water infrastructures are critical to providing the public with clean and safe water. The EPA's Clean Water and Drinking Water Infrastructure Sustainability Policy emphasizes the need to build on existing efforts to promote sustainable water infrastructure, working with states and water systems to employ robust, comprehensive planning processes to deliver projects that are cost effective over their life cycle, resource efficient, and consistent with community sustainability goals. The policy encourages communities to develop sustainable systems that employ effective utility management practices to build and maintain the level of technical, financial, and managerial capacity necessary to ensure long-term sustainability. A system in accordance with the present invention is a sustainable water infrastructure.

Case study research shows that people generally favor reuse of water that promotes water conservation, provides environmental protection benefits, and protects human health. However, where the source of the water is wastewater, attitudes change. The intensity of the public's reaction and concern over water reuse is magnified when the reuse issues change from nonpotable to potable reuse. Consumer surveys have been conducted in Orange County, California, where a water reuse initiative is underway. It found people are more willing to use recycled water from their own wastewater than from second parties or a common public source. In this regard, the present invention may not encounter as much public opposition as presently seen where large public projects reclaim wastewater. There is a factor, becoming known as the “yuck factor,” which is the impact on public perception of water reuse, depending on its source and use. Until the yuck factor decreases for the reuse of reclaimed sewer water for potable purposes, for example, the present invention will be useful because it has the capacity to distill graywater separately from sewer water and effluent thereby, again, reducing the yuck factor and making it more likely for the public to embrace the reuse of water. The invention has the further benefit of being able to use reclaimed effluent for non-potable purposes, which will, again reduce the yuck factor and increase its acceptance in the marketplace. See, Water Reuse: Understanding Public Perception and Participation (2003) published by WERF.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic flow chart depicting one embodiment of a system in accordance with the present invention, wherein the dashed lines indicate elements which may be optionally included in the depicted embodiment; and

FIG. 2 is a diagrammatic flow chart depicting a further embodiment of a system in accordance with the present invention, wherein the dashed lines indicate elements which may be optionally included in the depicted embodiment.

### DETAILED DESCRIPTION OF THE FIRST PREFERRED EMBODIMENTS

In order to facilitate the description of the invention, certain terms are defined below.

A clarifier is any vessel where a clarification process is conducted and consists of temporarily holding the sewage in a tank where heavy solids can settle to the bottom while oil, grease and lighter solids float to the surface. The clarifier allows for the settled and floating materials to be removed and the remaining liquid to be discharged or subjected to secondary treatment.

Coagulation is process employed to separate suspended solids from water. Finely dispersed solids (colloids) suspended in wastewaters are stabilized by negative electric charges on their surfaces, causing them to repel each other. Since this prevents these charged particles from colliding to form larger masses, called flocs, they do not settle. To assist in the removal of colloidal particles from suspension, chemical coagulation and sometimes flocculation are required. These processes, usually done in sequence, are a combination of physical and chemical procedures. Chemicals are mixed with wastewater to promote the aggregation of the suspended solids into particles large enough to settle or be removed.

Electrocoagulation means a process that separates solids from the water molecule. Solids that are normally held in solution by the hydrogen bond in the water molecule are “shocked” in a chamber of electrified rather than chemically treated. This reaction breaks the hydrogen bond, and the solids drop out of solution. This removes and destroys contaminants in the water, and allows the solids to be filtered.

An evaporator is a device used to intentionally evaporate aqueous waste in the air.

Microfiltration is a membrane technical filtration process which removes contaminants from a fluid (liquid & gas) by passage through a microporous membrane. Microfiltration can use a pressurized system but it does not need to include pressure.

Embodiments of a system in accordance with the present invention may generally comprise one or more of the following components: (1) the house plumbing, (2) the sewer line from house to a septic tank, (3) the traditional septic tank or ATU, (4) the septic tank or ATU outlet sewer pipe and flow control mechanism or draw mechanism, (5) effluent filter device and\or back flush mechanism, (6) the Distillation Unit and method to retrieve the waste produced by the Distillation Unit and direct the distiller waste back to the septic tank or to a separate waste tank where the distiller residue may, with the assistance of an evaporator, coagulation or electrocoagulation, or microfiltration reduce the volume of distiller residue for possible reintroduction to septic tank or disposal of the remaining distiller residue in a manner conforming to applicable laws; (7) a water holding tank (if the distilled water will be reused); (8) water pumping station and/or other necessary connectors, to return the distilled water to the home plumbing system to be used for all household uses (including drinking water), or separated by the home plumbing and directed only for graywater uses such as toilet flushing, irrigation and\or drip irrigation purposes; or (9) instead of being directed back to the home, an outlet pipe can discharge the distilled water from the Distillation Unit into a nearby body of water such as a creek, stream, river, lake or ocean or the distilled water can be released underground into the adjacent soils in a manner approved by the local regulatory authority to avoid erosion or by injection well into porous rock formations in a manner approved by regulatory authorities; (10) a water quality monitoring system capable of confirming that the water is safe drinking water, safe graywater or safe to discharge into the environment, such as a conductivity test together with an automatic shut-off valve designed to prohibit release upon test failure and (11) a method to generate energy to operate the Distillation Unit.

(1) Certain embodiments may include the house plumbing system which includes waste pipes, vent pipes and water traps. In one embodiment, the discharge of wastewater would occur, as is typical, from the house sewer pipe, which should meet local regulatory requirements, which may require a pipe slope of between 1 percent and 2 percent.

(2) In particular embodiments, the sewer line from the house to the septic tank should meet local regulatory requirements which usually require a plastic sewer pipe with glued joints or cast iron with stainless steel clamps or leaded joints. When using plastic pipe, the pipe should generally have a pressure rating equal to Schedule 40 or greater or otherwise meet local building regulations. The joints should be glued so they are watertight and resist root penetration.

(3) Like traditional septic systems, certain embodiments may provide that the house discharge sewer pipe will be at least a 4-inch diameter pipe, or otherwise meet local regulatory requirements. In this embodiment, the pipe should have a uniform slope with no high or low spots, without sharp bends in the house sewer system

(4) The septic tank used in an embodiment of a system in accordance with the present invention may have two compartments, and may be an ATU. The household wastewater may enter the septic tank through the house discharge sewer pipe. After passing through the inlet baffle, the solids may separate from the liquid as the sewage flows slowly through the septic tank. In one embodiment, oxygen may be added to the effluent in the septic tank causing aerobic bacteria to further break down the effluent. Some solids will settle to the bottom of the tank and others will float in the scum layer at the top. With certain embodiments, bacterial action will partially decompose the solids. The liquid that will discharge from the septic tank is herein referred to as “effluent.”

(5) Because the sedimentation process may not be completely efficient, it may be desirable, in certain embodiments, to filter fine particles and larger solids before allowing the effluent to enter to the Distillation Unit. This is especially useful when high peak (surge) flows occur due to the simultaneous discharge from several fixtures of the home resulting in a higher than usual concentration of suspended solids. The effluent screen or other effluent filter device can be located directly in the septic tank's sanitary tee or in a separate unit. An alarm device can be installed to warn owners of a blocked filter and malfunction. An effluent filter may provide for pre-treatment by, for example, electrocoagulation with the use, for example, of microfiltration by ceramic membrane before it is directed to the Distiller Unit. A plunger device can be installed to periodically clear the filter or it can be equipped with a backflow device to clear the filter device periodically.

(6) An automatic effluent control flow valve (e.g., part of the outlet flow control device) will release effluent from the septic tank or a device will draw from the septic tank, in certain embodiments, to one of the following: (a) in one embodiment, the effluent will flow into another chamber of the septic tank that will act as a clarifier until the home requires use of the distilled water or the effluent holding tank is full at which time the effluent will be released to flow to the Distillation Unit; (b) in another embodiment, the effluent will be sent by an effluent pump station to a separate effluent clarifier or holding tank and will be discharged or pumped to the Distillation Unit as and when needed for reuse; or (c) in one embodiment the effluent will simply be held in the septic tank by an automatic flow control device and will flow directly or via pump station to an input to the Distillation Unit, as needed, where it will be vaporized and condensed and the vaporized water will become “distilled water.” An effluent holding tank may be required in some circumstances to handle peak loads if the Distillation Unit is incapable of meeting the demand for distillation concurrent with the release of effluent. A particular embodiment may include a discharge line that will periodically remove the concentrated impurities, e.g., distiller waste, from the boiling chamber (or other available location) of the Distillation Unit. In one embodiment, the distiller waste can be directed back to the sewer inlet valve or directed and stored in a separate hazardous material storage tank where the distiller residue may be allowed to evaporate, with the assistance of an evaporator or the distiller waste may be made subject to an coagulation or electrocoagulation process and with, for example, the use of microfiltration with, for example, a ceramic membrane my reduce the volume of distiller residue for possible reintroduction to septic tank or for subsequent collection and disposal by a licensed hazardous material hauler. In one embodiment, the Distillation Unit may be located aboveground and may be located within the home structure or a separate structure such as a prefabricated shed or storage unit that provides support for solar panels used in generating the energy required to operate the Distiller Unit and to also permit easy access to all of the above-mentioned equipment. (Note: an evaporator may be used pursuant to 40 CFR 261.5, so long as volatile hazardous constituents are less than 1 part per million, and, as a practical matter will only be utilized if odors can be controlled).

(7) In certain embodiments, the distilled water will travel by pipe and gravity flow or a pumping station to a water holding tank appropriate for the storage of distilled water, such as a stainless steel tank, sized to handle the estimated daily flow of effluent to the Distillation Unit. In an embodiment in which the distilled water will be used for human consumption, care should be taken to avoid the re colonization of bacteria according to appropriate protocols for the storage of distilled water. The general principals include (i) moderation of temperature (water stored at below 40 degrees Fahrenheit where possible); (ii) avoidance of deadlegs in pipe work and other circulation networks; (iii) regular cleaning and checking of quality; (iv) circulation of water where it may be stored for long periods (e.g., family vacations); and (v) regular disinfection or UV treatment of fittings or by hot water circulation. Disinfectant may be needed. Protocols established for the testing and treatment of stored distilled water by local regulatory agencies should be followed. In an embodiment, the holding tank may provide for access for easy testing of the water and may provide for a method for the introduction of chemical and nonchemical additives, as necessary. Because low mineralized water is highly aggressive to materials with which it comes into contact (e.g., the storage tank, the pumping station and its components), at this stage, particular embodiments will provide for total dissolved solids (TDS) to be added to the distilled water by an appropriate automatic-timed release mechanism (or by other method) so that the distilled water will maintain at least 100 mg/l of TDS, 10-30 mg/l magnesium, and 20-50 mg/l calcium, and for total water hardness, the sum of calcium and magnesium should be 2 to 4 mmol/l in order to improve taste, keep water holding tank and associated piping safe and meet World Health Organization recommendations. In particular embodiments, the holding tank will have a high-water alarm to avoid an overflow. The holding tank may be located above ground and it may be located within the home structure or separate structure. In one embodiment, the separate structure may serve as a garage for the septic tank, Distillation Unit, evaporator and distillate holding tank, the frame for which may be made to support solar panels to provide the energy (or a portion thereof) to run the Distillation Unit or, at the very least, to provide for an emergency supply of light and energy as a back-up during emergencies. In certain embodiments, no distilled water holding tank will be necessary if the Distillation Unit can be modified to provide for the distillation of effluent as and when needed at peak periods within the home.

(8) If the distilled water cannot flow by gravity to the home, in another embodiment, another pumping station may be used to lift the distilled water to the home water inlet. In addition to allowing the home to be uphill from the septic tank and Distillation Unit, in some embodiments, the distilled water pumping system can deliver the distilled water to the home in small doses all day, or as and when needed.

(9) Recognizing that some homeowners will not want to consume the distilled water produced by a system because they are psychologically unprepared to consume reclaimed effluent, or because local regulations will not allow the reuse of the distilled water generated by the system for potable purposes, or graywater uses or because it will be less expensive (initially) to discharge rather than reuse the distilled water, in another embodiment, the distilled water may be designed to discharge directly from the Distillation Unit into a nearby body of water such as an adjacent creek, river, lake or ocean, or into soils in any manner that would avoid erosion or by injection well into porous rock formations in an approved manner. Alternatively the home plumbing system can be modified to include, for example, a back flow protection device and color coded water lines consistent with current statutes and regulations to assure that the use of the water is restricted to graywater purposes such as toilet flushing and irrigation, car washing and similar non potable purposes. Another embodiment may include a combination of the above methods of releasing the distilled water and not reusing the distilled water, e.g., in order to maintain a continuous flow of the distilled water it may be advantageous to allow the distilled water to release from the holding tank continuously whether or not there is a household need for same.

(10) Certain embodiments may provide for an output sensor (e.g., as part of a water quality monitor system) to be a water quality sensor including one or more of turbidity, conductivity, and temperature sensors. The monitoring system may be further modified within an embodiment to provide for the ability to monitor additional water quality attributes in order to assure the distilled water, when used as drinking water or graywater purposes, will meet the standards applicable to such use published by a state regulatory agency and\or the EPA.

(11) Energy for the Distillation Unit may be supplied within various embodiments of the system by (a) electricity supply from the home or municipal power grid; (b) a Stirling cycle engine driving an electric generator; and in one embodiment, the fuel supply for the Stirling cycle engine may be supplied by the product of, for example, incineration of household debris including polyethylene, polystyrene and polypropylene, or by biogas obtained from the anaerobic digestion occurring in the septic tank (removing, if possible hydrogen sulfide), or any other fuel capable of running the Stirling cycle engine; or (c) by prior art solar energy systems capable of providing an adequate energy supply to the Distillation Unit.

### DETAILED DESCRIPTION OF FURTHER PREFERRED EMBODIMENTS

Where an embodiment of a system or method herein does not involve the use of blackwater (e.g., water contaminated with animal, human, or food waste) or an OWTS, but instead involves only the purification of graywater or rainwater for potable or nonpotable purposes, certain embodiments may generally comprise one or more of the following components: (A) rainwater and\or stormwater collection or (B) (1) the house plumbing, (2) source separator plumbing directing black water only to the municipal waste system or septic system and directing the gray water via home plumbing, or rain water from a rainwater tank or cistern via a pipe to the Distillation Unit, (3) the Distillation Unit and method to retrieve the waste produced by the Distillation Unit and direct the distiller waste back to the septic tank or to a separate distiller waste tank where the distiller residue may, with the assistance of an evaporator, be reduced so the volume of distiller residue will be less for the possible reintroduction of the distiller waste to the septic tank or for the disposal of the remaining distiller residue in a manner conforming to applicable laws; (4) a water holding tank (if the distilled water will be reused); (5) water pumping station and/or other necessary connectors, to return the distilled water to the home plumbing system to be used for all household uses (including drinking water), or separated by the home plumbing and directed only for toilet flushing and all irrigation or drip irrigation; or (6) instead of being directed back to the home, where graywater is the source water, an outlet pipe can discharge the distilled water from the Distillation Unit into a nearby body of water such as a creek, stream, river, lake or ocean or the distilled water can be released underground into the adjacent soils in a manner approved by the local regulatory authority to avoid erosion or by injection well into porous rock formations in a manner approved by regulatory authorities; (7) a water quality monitoring system capable of confirming that the water is safe drinking water, safe gray water or safe to discharge into the environment, such as a conductivity test; and (8) a method to generate energy to operate the Distillation Unit.

(A) Certain embodiments may include rainwater and/or storm water collection devices which may include (i) a filter which excludes leaves and other debris from the roof or gutters; (ii) a storage or holding tank, cistern or swimming pool; and (iii) a submersible pump which pumps water to the Distillation Unit from the holding tank or swimming pool.

(1) Certain embodiments may include the house plumbing system which includes pipes, vent pipes and water traps directly water from clothes washers, bathtubs, showers and sinks, but not from wastewater from kitchen sinks, dishwashers or toilets. In one embodiment, the discharge of grey wastewater would occur from a graywater pipe, which should meet local regulatory requirements, which may require a pipe slope of between 1 percent and 2 percent.

(2) In particular embodiments, the graywater line from the house or the rainwater line from the cistern or swimming pool to the Distillation Unit should meet local regulatory requirements which usually require a plastic pipe with glued joints or cast iron with stainless steel clamps or leaded joints. When using plastic pipe, the pipe should generally have a pressure rating equal to Schedule 40 or greater or otherwise meet local building regulations. The joints should be glued so they are watertight and resist root penetration.

(3) In an embodiment, the household graywater may enter a holding tank through the house discharge graywater pipe.

(4) In one embodiment, an automatic graywater control flow valve (e.g., part of the outlet flow control device) will release graywater from the graywater holding tank, or an automatic rainwater control flow valve (e.g., part of the outlet flow control device) from the cistern, or swimming pool in certain embodiments, through a 100 micron filter, to one of the following: (a) the graywater or rainwater, as the case may be, will be sent by a pump station to an input to the Distillation Unit, as needed, where it will be vaporized and condensed and the vaporized water will become “distilled water.” A particular embodiment may include a discharge line that will periodically remove the concentrated impurities from the boiling chamber (or other available location) of the Distillation Unit. In one embodiment, these impurities can be directed back to the sewer inlet valve or directed and stored in a separate hazardous material storage tank where the distiller residue may be allowed to evaporate, with the assistance of an evaporator, and thereby reduce the volume of distiller residue for possible reintroduction to septic tank or for subsequent collection and disposal by a licensed hazardous material hauler. In one embodiment, the Distillation Unit may be located aboveground and may be located within the home structure or separate structure that permits easy access. (Note: An evaporator may be used, for example, pursuant to 40 CFR 261.5, so long as volatile hazardous constituents are less than 1 part per million, and as a practical matter will only be used if odors can be controlled.)

(5) In certain embodiments, the distilled water will travel by pipe and gravity flow or a pumping station to a water holding tank appropriate for the storage of distilled water, such as a stainless steel tank, sized to handle the estimated daily flow of graywater or rainwater, as the case may be to the Distillation Unit. In an embodiment in which the distilled water will be used for human consumption, care should be taken to avoid the re colonization of bacteria according to appropriate protocols for the storage of distilled water. UV treatment or disinfectant may be needed. Protocols established for the testing and treatment of stored distilled water by local regulatory agencies should be followed. The general principals include (i) moderation of temperature (water stored at below 40 degrees Fahrenheit where possible); (ii) avoidance of deadlegs in pipe work and other circulation networks; (iii) regular cleaning and checking of quality; (iv) circulation of water where it may be stored for long periods (e.g., family vacations); and (v) regular disinfection or UV treatment of fittings or by hot water circulation. In an embodiment, the holding tank may provide for access for easy testing of the water and may provide for a method for the introduction of chemical and nonchemical additives, as necessary. Because low mineralized water is highly aggressive to materials with which it comes into contact (e.g., the storage tank, the pumping station and its components), at this stage, particular embodiments will provide for total dissolved solids (TDS) to be added to the distilled water by an appropriate automatic-timed release mechanism (or by other method) so that the distilled water will maintain at least 100 mg/l of TDS, 10-30 mg/l magnesium, and 20-50 mg/l calcium, and for total water hardness, the sum of calcium and magnesium should be 2 to 4 mmol/l in order to improve taste, keep water holding tank and associated piping safe and meet World Health Organization recommendations. In particular embodiments, the holding tank will have a high-water alarm to avoid an overflow. The holding tank may be located above ground and it may be located within the home structure or separate structure. In one embodiment, the separate structure may serve as a shed or garage for cistern or stormwater catchment, Distillation Unit, evaporator and distillate holding tank, the frame for which may be made to support solar panels to provide the energy (or a portion thereof) to run the Distillation Unit and\or to provide for an emergency supply of light and energy as a back-up during emergencies. In certain embodiments, no distilled water holding tank will be necessary if the Distillation Unit can be modified to provide for the distillation of graywater from the house or rainwater from the cistern or swimming pool as and when needed at peak periods within the home.

(7) If the distilled water cannot flow by gravity to the home, in another embodiment, another pumping station may be used to lift the distilled water to the home water inlet. In addition to allowing the home to be uphill from the holding tank and Distillation Unit, in some embodiments, the distilled water pumping system can deliver the distilled water to the home in small doses all day, or as and when needed.

(8) Recognizing that some homeowners will not want to consume the distilled water produced by a system because they are psychologically unprepared to consume reclaimed graywater or natural source water, or because local regulations will not allow the reuse of the distilled water generated by the system for potable purposes, in another embodiment, where the source water is graywater, the distilled water may be designed to discharge directly from the Distillation Unit into a nearby body of water such as an adjacent creek, river, lake or ocean, or into soils in any manner that would avoid erosion. Alternatively the home plumbing system can be modified to include, for example, a back flow protection device and color coded water lines consistent with current statutes and regulations to assure that the use of the water is restricted to graywater purposes such as toilet flushing and irrigation, car washing and similar non potable purposes. Another embodiment may include a combination of the above methods of releasing the distilled water and not reusing the distilled water, e.g., in order to maintain a continuous flow of the distilled water it may be advantageous to allow the distilled water to release from the holding tank continuously whether or not there is a household need for same.

(9) Certain embodiments may provide for an output sensor (e.g., as part of a water quality monitor system) to be a water quality sensor including one or more of turbidity, conductivity, and temperature sensors. The monitoring system may be further modified within an embodiment to provide for the ability to monitor additional water quality attributes in order to assure the distilled water, when used as drinking water or graywater purposes, will meet the standards applicable to such use published by a state regulatory agency and\or the EPA.

(10) Energy for the Distillation Unit may be supplied within various embodiments of the system by (a) electricity supply from the home or municipal power grid; (b) a Stirling cycle engine driving an electric generator; and in one embodiment, the fuel supply for the Stirling cycle engine may be supplied by the product of, for example, incineration of household debris including polyethylene, polystyrene and polypropylene, or by biogas obtained from the anaerobic digestion occurring in the septic tank (removing, if possible hydrogen sulfide), or any other fuel capable of running the Stirling cycle engine; or (c) by prior art solar energy systems capable of providing an adequate energy supply to the Distillation Unit.

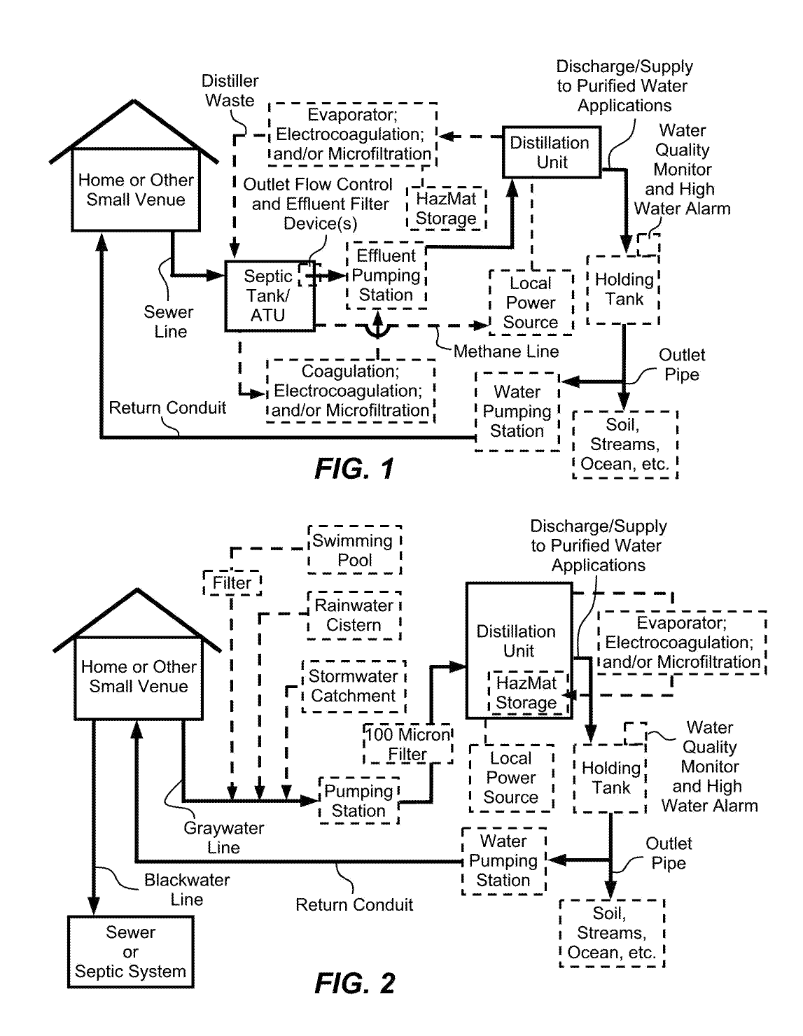

Referring to FIG. 1 for illustration, embodiments of a method of purifying and recycling septic tank effluents may comprise transporting wastewater into a septic tank; separating effluent from the wastewater within said septic tank; moving the effluent at a flow rate from the septic tank to a distillation unit; distilling the effluent by way of the distillation unit, thereby generating purified water and distiller residue; reducing the volume of the distiller residue; and supplying at least a portion of the purified water to one or more purified water applications. Depending upon the particular embodiment of such a method, the step of reducing may occur by way of one or more volume reduction processes selected from the group consisting of evaporation, coagulation, electrocoagulation and microfiltration, as previously described. Certain embodiments may comprise the step of reintroducing the distiller residue to the septic tank after step of reducing. The step of transporting may be from a sewer line of a home; and the purified water applications may include the provision of potable water to said home.

Particular embodiments of a method in accordance with the present invention may further comprise the steps of monitoring the quality of the purified water to determine whether it meets a safety threshold appropriate for use in the purified water application, and automatically terminating the supplying if the safety threshold is not met. Embodiments my include the step of holding the purified water in a holding tank prior to supplying the purified water to the one or more purified water applications. In such embodiments, the aforementioned step of monitoring may be applied to the purified water being held in the holding tank. Embodiments may include the step of automatically releasing total dissolved solids into the purified water.

Certain embodiments of a method may further comprise the step of providing an effluent filter in fluid communication between the septic tank and the distillation unit, wherein said effluent filter is adapted to trigger an alarm device if said effluent filter malfunctions or becomes blocked. The effluent filter may be adapted to electrocoagulate the effluent.

In particular embodiments, the distillation unit may located substantially above ground within, for example, a housing structure adapted to, for example, support one or more solar panels wherein the one or more solar panels may be connected to the distillation unit to supply power thereto. Embodiments may provide a stored power backup, such as a battery or battery array, electrically connect to the distillation unit to ensure the distillation unit is able to continue operating during power grid outages or temporary failures of local power sources.

In certain embodiments, the step of distilling may occur by way of vapor compression distillation within the distillation unit. A local power source may be operated for providing power to the distillation unit, wherein the local power source may be operating independently of any electrical grid. The local power source may include, for example, a Stirling cycle engine. Particular embodiments which employ a Stirling cycle engine may, for example, include incinerating household debris, thereby generating heat for the operation of the Stirling cycle engine. Embodiments employing a Stirling cycle engine may further comprise collecting methane, wherein the methane may be a byproduct of an anaerobic digestion process having occurred within the septic tank, and burning the methane, thereby generating heat for the operation of the Stirling cycle engine.

Referring to FIG. 2 for illustration, embodiments of a method of purifying and recycling unpurified water may comprise: moving the unpurified water from a source to a distillation unit; distilling the unpurified water by way of said distillation unit, thereby generating purified water and distiller residue; reducing the volume of the distiller residue; and supplying at least a portion of the purified water to one or more purified water applications. In certain embodiments of such a method, the source may be selected from the group consisting of a swimming pool, a rainwater cistern, a stormwater catchment and a graywater line. The step of reducing may occur by way of, for example, one or more volume reduction processes selected from the group consisting of evaporation, coagulation, electrocoagulation and microfiltration.

Referring again to FIG. 1 for illustration, embodiments of a system for purifying and recycling septic tank effluents may comprise a sewer line of a home, a septic tank, a distillation unit, a volume reduction device and a discharge line. The sewer line may be adapted to transporting wastewater from the home. The septic tank may be for receiving the wastewater and separating effluent therefrom. The distillation unit may be for receiving the effluent at a flow rate and distilling the effluent, thereby generating purified water and distiller residue. The distillation unit may include a vapor water distillation component. The volume reduction device may be for reducing the volume of the distiller residue by way of a volume reduction process. The discharge line may be for discharging the purified water to one or more purified water applications. The volume reduction process may be one or more of evaporation, coagulation, electrocoagulation and microfiltration. One or more embodiments may comprise a local power source for providing power to the distillation unit, wherein the local power source may be adapted to operate independently of any electrical grid. The local power source may include, for example, a Stirling cycle engine.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of purifying and recycling septic tank effluents, said method comprising:
transporting wastewater into a septic tank;
separating effluent from said wastewater within said septic tank;
moving said effluent at a flow rate from said septic tank to a distillation unit;
distilling said effluent by way of said distillation unit, thereby generating purified water and distiller residue;
reducing the volume of said distiller residue; and
supplying at least a portion of said purified water to one or more purified water applications.

2. A method as defined in claim 1 in which said reducing occurs by way of one or more volume reduction processes selected from the group consisting of evaporation, coagulation, electrocoagulation and microfiltration.

3. A method as defined in claim 1 further comprising reintroducing said distiller residue to said septic tank after said reducing.

4. A method as defined in claim 1 further comprising:
monitoring the quality of said purified water to determine whether it meets a safety threshold appropriate for use in said purified water application; and
automatically terminating said supplying if said safety threshold is not met.

5. A method as defined in claim 1 further comprising:
providing an effluent filter in fluid communication between said septic tank and said distillation unit, wherein said effluent filter is adapted to trigger an alarm device if said effluent filter malfunctions or becomes blocked.

6. A method as defined in claim 5 in which said effluent filter is adapted to electrocoagulate said effluent.

7. A method as defined in claim 1 in which said distillation unit is located above ground within a housing structure adapted to support one or more solar panels wherein said one or more solar panels are power supplyingly connected to said distillation unit.

8. A method as defined in claim 1 in which said distillation unit is electrically connected to a stored power backup.

9. A method as defined in claim 1, further comprising:
holding said purified water in a holding tank prior to supplying said purified water to said one or more purified water applications.

10. A method as defined in claim 1 further comprising:
automatically releasing total dissolved solids into said purified water.

11. A method as defined in claim 1 in which said distilling occurs by way of vapor compression distillation within said distillation unit.

12. A method as defined in claim 1 in which:
said transporting is from a sewer line of a home; and
said purified water applications include the provision of potable water to said home.

13. A method as defined in claim 1, further comprising:
operating a local power source for providing power to said distillation unit, wherein said local power source is operating independently of any electrical grid.

14. A method as defined in claim 13 in which said local power source includes a Stirling cycle engine.

15. A method as defined in claim 14, further comprising;
incinerating household debris, thereby generating heat for the operation of said Stirling cycle engine.

16. A method as defined in claim 14, further comprising;
collecting methane, wherein said methane is a byproduct of an anaerobic digestion process having occurred within said septic tank; and
burning said methane, thereby generating heat for the operation of said Stirling cycle engine.

17. A method of purifying and recycling unpurified water, said method comprising:
moving said unpurified water from a source to a distillation unit;
distilling said unpurified water by way of said distillation unit, thereby generating purified water and distiller residue;
reducing the volume of said distiller residue; and
supplying at least a portion of said purified water to one or more purified water applications.

18. A method as defined in claim 17 in which said source is selected from the group consisting of a swimming pool, a rainwater cistern, a stormwater catchment and a graywater line.

19. A method as defined in claim 17 in which said reducing occurs by way of one or more volume reduction processes selected from the group consisting of evaporation, coagulation, electrocoagulation and microfiltration.

20. A system for purifying and recycling septic tank effluents, said system comprising:
a sewer line of a home, said sewer line being adapted to transporting wastewater from said home;
a septic tank for receiving said wastewater and separating effluent therefrom;
a distillation unit for receiving said effluent at a flow rate and distilling said effluent, thereby generating purified water and distiller residue, said distillation unit including a vapor water distillation component;
a volume reduction device for reducing the volume of said distiller residue by way of a volume reduction process; and
a discharge line for discharging said purified water to one or more purified water applications.

21. A system as defined in claim 20 in which said volume reduction process is selected from the group consisting of evaporation, coagulation, electrocoagulation and microfiltration.

22. A system as defined in claim 20, further comprising:
a local power source for providing power to said distillation unit, wherein said local power source is adapted to operate independently of any electrical grid.

23. A system as defined in claim 20 in which said local power source includes a Stirling cycle engine.
